(19) United States
(12) Patent Application Publication
(10) Pub. No.: US 2009/0002435 A1
(43) Pub. Date: Jan. 1, 2009

(54) NOZZLE CHIP CLEANING APPARATUS OF INKJET PRINTER AND INKJET PRINTER WITH THE SAME

(75) Inventors: Hee-yuel ROH, Suwon-si (KR); Dong-woo Ha, Hwaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/933,617

(22) Filed: Nov. 1, 2007

(30) Foreign Application Priority Data
Jun. 26, 2007 (KR) 200763138

(51) Int. Cl. B41J 2/165

(52) U.S. Cl. 347/33

(57) ABSTRACT

A nozzle chip cleaning apparatus of an inkjet printer with an improved supply/return structure for a cleaning solution for cleaning a nozzle chip includes a flexible bag to hold fluid and to contact a nozzle chip of an inkjet head. A lifting apparatus may move the flexible bag to be in contact with a surface of the nozzle chip. The nozzle chip cleaning apparatus employs a method in which a flexible bag wipes a surface of a nozzle chip cleaning solution.

### CROSS-REFERENCE TO RELATED APPLICATIONS

This application claims the benefit of Korean Patent Application No. 10-2007-0063138, filed on Jun. 26, 2007, in the Korean Intellectual Property Office, the disclosure of which is incorporated herein in its entirety by reference.

### BACKGROUND OF THE INVENTION

1. Field of the Invention

The present general inventive concept relates to a nozzle chip cleaning apparatus of an inkjet printer.

2. Description of the Related Art

Generally, an inkjet printer is a device that prints an image by ejecting ink droplets through a nozzle chip onto a desired position on a printing medium. Inkjet printers are classified into a shuttle type and an array type according to a form of a head that ejects the ink droplets. The shuttle type inkjet printer includes a head having a single type inkjet printer that prints while reciprocating in a width direction of paper. On the other hand, the array type inkjet printer prints by arranging a plurality of nozzle chips in a line in the width direction of the paper. Presently, the array type inkjet printer is preferred between the two because of its high speed printing characteristic.

If a printing operation is repeatedly performed using such inkjet heads, an ink droplet outlet may be plugged, for example, because ink pooled in the ink droplet outlet of a nozzle chip solidifies. As a result, the ink droplets cannot flow out of the plugged ink droplet outlet, and thus, a desired image cannot be properly printed. To solve the above problem, a related art inkjet printer includes a cleaning apparatus for cleaning an outlet of a nozzle chip, if required. Such a related art cleaning apparatus cleans the outlet of the nozzle chip with a predetermined cleaning solution and generally has a structure as illustrated in FIG. 1. FIG. 1 illustrates an array type inkjet head 20 having a structure in which a cleaning tank 11 is disposed to be able to reciprocate in a width direction of paper so as to clean a plurality of nozzle chips 21 arranged in the width direction of the paper. A feeding pipe 14 is for supplying a cleaning solution to the cleaning tank 11. A drain pipe 15 is for returning the cleaning solution used in the cleaning tank 11 to a storage tank 13. If the nozzle chip 21 is cleaned using the related art cleaning apparatus having such a structure, the cleaning solution is supplied to the cleaning tank 11 through the feeding pipe 14, and then an ultrasonic device 12 is driven so as to vibrate. Then, the cleaning solution 16 that entered the cleaning tank 11 is shaken, and then shoots up to collide against the nozzle chip 21 and clean an outlet 21a of the nozzle chip 21. After the cleaning is finished, the cleaning solution used for the cleaning is returned to the storage tank 13 through the drain pipe 15.

However, since such a related art cleaning apparatus requires a large and/or complicated apparatus for supplying and returning the cleaning solution to the cleaning tank 11, its structure is increased, more complicated and needs additional space in the inkjet printer. Accordingly, it is difficult to make the inkjet printer compact and light. In addition, a great quantity of the cleaning solution 16 in the cleaning tank 11 is likely to overflow from the cleaning tank 11 to contaminate the elements around the cleaning tank 11 during movement of the cleaning tank 11 (e.g., by the ultrasonic device 12), and thus, methods for solving such a problem are required.

### SUMMARY OF THE INVENTION

The present general inventive concept provides a nozzle chip cleaning apparatus of an inkjet printer that does not directly use a cleaning solution when cleaning a nozzle chip, and an inkjet printer using the nozzle chip cleaning apparatus.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a nozzle chip cleaning apparatus of an inkjet printer including a flexible bag disposed in a housing to face a nozzle chip of an inkjet head and to be filled with fluid, an oscillation device to vibrate the flexible bag and a lifting apparatus to raise and lower the housing so that the flexible bag reaches a surface of the nozzle chip.

The foregoing and/or other aspects and utilities of the present general inventive concept may also be achieved by providing an inkjet printer including an inkjet head to emit ink droplets onto a printing medium through a nozzle chip to form an image, and a nozzle chip cleaning apparatus to clean the nozzle chip, wherein the nozzle chip cleaning apparatus includes a flexible bag disposed in a housing to hold fluid, an oscillation device to vibrate the flexible bag and a lifting apparatus to raise and lower the housing to contact a surface of the nozzle chip with the flexible bag.

The oscillation device may be an ultrasonic device.

The lifting apparatus may include a cam shaft connected to the housing to rotate about a lifting trace of the housing and a driving motor to rotate the cam shaft.

The nozzle chip cleaning apparatus may further include a flexible bag cleaning unit to clean a contacting surface of the flexible bag. The flexible bag cleaning unit may include a spray head having a chamber to admit a cleaning solution and spray holes to emit the cleaning solution to the outside and an oscillation device disposed in the chamber, wherein when the oscillation device oscillates to spray the cleaning solution onto the surface of the flexible bag through the spray holes.

The nozzle chip cleaning apparatus may further include a buffer spring to absorb shock generated when the flexible bag reaches the surface of the nozzle chip by supporting the flexible bag.

The foregoing and/or other aspects and utilities of the present general inventive concept may also be achieved by providing a nozzle chip cleaning apparatus for an inkjet printer that includes a flexible bag adapted to contain fluid and a device to position the flexible bag or an inkjet printer head at a cleaning position.

The foregoing and/or other aspects and utilities of the present general inventive concept may also be achieved by providing an image processing apparatus including an inkjet head to emit ink droplets through a nozzle chip and a nozzle chip cleaning apparatus to clean the nozzle chip, where the nozzle chip cleaning apparatus includes a flexible bag adapted to contain fluid and to contact an emitting surface of the nozzle chip.

The foregoing and/or other aspects and utilities of the present general inventive concept may also be achieved by providing a method for cleaning an image processing apparatus including emitting ink droplets through a nozzle chip and reciprocally moving a flexible bag adapted to contain fluid between a first position adjacent a surface of the nozzle chip and a second position.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a diagram that illustrates a structure of a related art cleaning apparatus;

FIG. 2 is a diagram that illustrates a structure of an inkjet printer employing a nozzle chip cleaning apparatus according to an embodiment of the present general inventive concept;

FIG. 3 is a diagram that illustrates a partial perspective view of the nozzle chip cleaning apparatus illustrated in FIG. 2 according to an embodiment of the present general inventive concept;

FIG. 4 is a diagram that illustrates a method of cleaning a flexible bag of the nozzle chip cleaning apparatus illustrated in FIG. 2 according to an embodiment of the present general inventive concept; and

FIG. 5 is a diagram that illustrates an exemplary method operation of a nozzle chip cleaning apparatus according to an embodiment of the present general inventive concept.

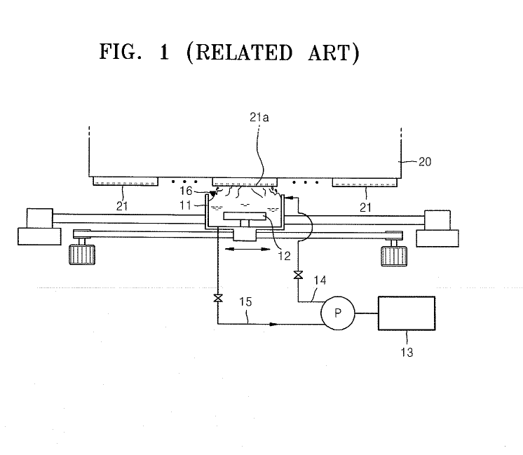

### DETAILED DESCRIPTION OF EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

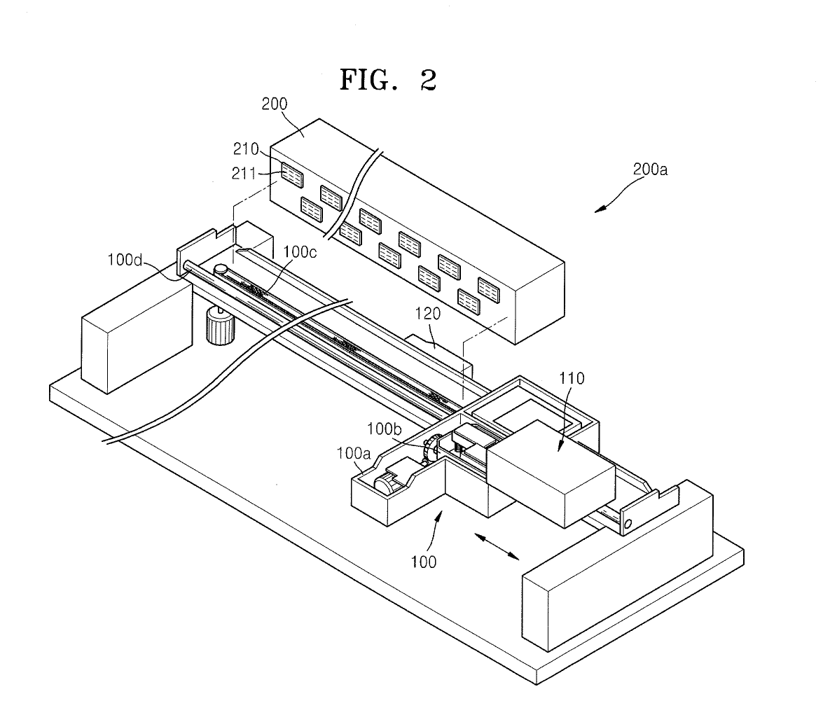

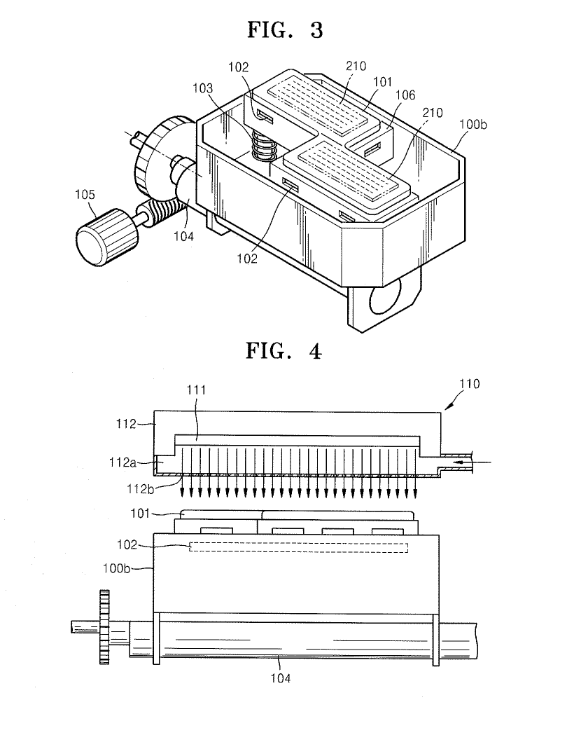

FIG. 2 illustrates a structure of an inkjet printer 200a employing a nozzle chip cleaning apparatus 100 according to an embodiment of the present general inventive concept. FIG. 3 illustrates a partial perspective view of the nozzle chip cleaning apparatus 100 illustrated in FIG. 2. The inkjet printer may include a printing medium feeding unit to pick-up and feed a printing medium, a printing unit having an array type inkjet head 200 to form or print an image on the printing medium, and a discharge unit to discharge the printing medium.

In the embodiment of FIG. 2, the exemplary array type inkjet head 200 may be used to print and has a plurality of nozzle chips 210 arranged in a width direction of paper as a printing medium. However, embodiments of the present general inventive concept may be applied to other inkjet heads or inkjet printers such as shuttle type inkjet printers.

In the embodiment of FIG. 2, in order to clean the nozzle chips 210 of the array type inkjet head 200, the nozzle chip cleaning apparatus 100 has a structure in which a flexible bag 101, which may be filled with fluid, is movable to rub or contact a surface of a nozzle chip 210 to wipe or clean an outlet 211 of the nozzle chip 210. Thus, the embodiment of FIG. 2 does not have a structure in which a cleaning solution is shaken using an oscillation device to directly collide the cleaning solution against the surface of a nozzle chip (e.g., the nozzle chip 210) as in the related art technology. For example, the nozzle chip cleaning apparatus 100 may include an outer housing 100a to reciprocate along a guide rail 100d when a circular belt 100c is driven. An inner housing 100b, which may be inside the outer housing 100a, may include the flexible bag 101, a vibrating member such as an ultrasonic device 102 and a supporting member 106. The ultrasonic device 102 (e.g., an oscillation device) may transmit a vibration to fluid filled in the flexible bag 101 so as to shake the flexible bag 101. The flexible bag 101 and the ultrasonic device 102 may be mounted at the supporting member 106. The supporting member 106 is preferably supported by a buffer spring 103 so as to be able to be flexibly shaken. The inner housing 100b is configured to be movable such that the flexible bag 101 may contact a surface of the nozzle chip. For example, the inner housing 100b may be coupled with a cam shaft 104 set to rotate about an eccentric trace by a driving motor 105 to raise and lower the inner housing 100b during rotation of the cam shaft 104 (e.g., along the eccentric trace). Here, when the inner housing 100b is raised and lowered during rotation of the cam shaft 104, the flexible bag 101 may stick to or separate from a surface of the nozzle chip 210 above the flexible bag 101. However, embodiments of the present general inventive concept are not intended to be limited by such an exemplary disclosure, for example, other configurations could be used to position or reciprocally move the flexible bag 101 between a first position (e.g., a storage position) and a second position (e.g., a cleaning position).

A flexible bag cleaning unit 110 may be disposed to clean a surface of the flexible bag 101 in the outer region of the inkjet head 200. The flexible bag cleaning unit 110 is a device to clean (e.g., remove ink marks) the flexible bag 101. For example, ink marks may occur when the flexible bag 101 wipes the outlet 211 of the nozzle chip 210 with the cleaning solution. As illustrated in FIG. 4, the flexible bag cleaning unit 110 includes a spray head 112 to spray the cleaning solution through spray holes 112b. For example, the spray head 112 may spray the cleaning solution through spray holes 112b using oscillations of an ultrasonic device 111 formed in the flexible bag cleaning unit 110. That is, the ink marks, which may be smeared on the surface of the flexible bag 101, are cleaned while the cleaning solution that is filled in a chamber 112a is sprayed through the spray holes 112b by movement of the chamber 112a or flexible bag cleaning unit 110 (e.g., the oscillations of the ultrasonic device 111 like a humidifier). The sprayed cleaning solution may collect in a lower portion of the outer and/or inner housings 100a and 100b after cleaning the ink marks. For example, a cleaning solution tank 120 may supply the cleaning solution to the flexible bag cleaning unit 110.

An exemplary embodiment of a method for cleaning an image forming apparatus according to the present general inventive concept will now be described. The cleaning method embodiment can be used with and will be described using embodiments of FIGS. 2-4, however, the present general inventive concept is not intended to be limited thereby. Thus, cleaning by the nozzle chip cleaning apparatus 100 having the above structure may be performed according to such a method.

First, operations to clean the nozzle chip cleaning apparatus 100 may begin when the outer housing 100a is moved under the nozzle chip 210 that is to be cleaned (e.g., moved along a guide rail 100d by rotating a circular belt 100c to be directly under one of the nozzle chips 210). Such an operation is performed when the inkjet head is an array type. In an alternative embodiment when the inkjet head is a shuttle type, the cleaning may be performed by moving the inkjet head onto the flexible bag 101.

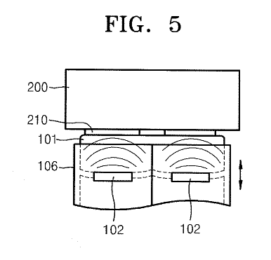

When cleaning of the nozzle chip 210 is to start, the inner housing 100b may be moved so that the flexible bag 101 sticks to a surface of the nozzle chip 210 as illustrated in FIG. 5. For example, the cam shaft 104 may be rotated by the driving motor 105 the inner housing is raised. Then, the flexible bag 10 may clean or wipe the surface of the nozzle chip 210 (while being shaken or reciprocally driven). For example, the ultrasonic device 102 preferably oscillates to transmit a vibration through fluid filled in the flexible bag 101 to wipe clean the surface of the nozzle chip 210 using the flexible bag 101. Since cleaning of the nozzle chip 210 may be performed without wetting the nozzle chip 210 with a cleaning solution according to embodiments of the present general inventive concept, there is no possibility or a reduced possibility for the cleaning solution to overflow. Furthermore, since the nozzle chip 210 is wiped with the flexible bag 101 that is sealed and filled with fluid, it is unnecessary to repeatedly supply and return the cleaning solution like the related art cleaning apparatus.

When cleaning of one nozzle chip 210 is finished, the outer housing 100a may be moved to a next position of the next nozzle chip 210 in case of an array type inkjet head. For example, the outer housing could be moved to a plurality of cleaning positions (e.g., second positions) by rotating the circular belt 100c, and then exemplary cleaning methods by lifting and oscillation may be repeated.

Then, when the cleaning method for all the nozzle chips 210 is finished, the outer housing 100a may be moved to the location of the flexible bag cleaning unit 110. In this state, when the ultrasonic device 111 of the spray head 112 is driven as illustrated in FIG. 4, the cleaning solution filled in the chamber 112a may be sprayed onto the flexible bag 101 in the form of mist through the spray holes 112b. Then, the sprayed cleaning solution may operate to clean the flexible bag 101 (e.g., to clean the ink marks smeared onto the surface of the flexible bag 101). Therefore, the cleaning of the nozzle chips 210 using the flexible bag 101 may be completed.

According to the present general inventive concept, the flexible bag 101 may be made of materials, for example, vinyl, rubber, or the like. Such materials have characteristics that can easily transmit an external vibration to fluid filled in the flexible bag and can easily transmit shaking of the fluid to the outside. Also, it is noted that in an alternative embodiment, the flexible bag may only be flexible on a portion intended to contact the nozzle chip.

As described above, embodiments of a nozzle chip cleaning apparatus of an inkjet printer and methods thereof according to the present general inventive concept may use a flexible bag to clean or wipe a surface of a nozzle chip. Accordingly, there is little or no possibility for the cleaning solution to overflow. Furthermore, since it is unnecessary to have a complicated structure in which the cleaning solution should be supplied and returned to a movable cleaning tank, it is easy to manufacture the inkjet printer compact, at a reduced cost and light.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

Although a few embodiments of the present general inventive concept has been shown and described, it will be appreciated by those skilled in the art that changes made be made in these embodiments without departing from the principles and spirit and scope of the present general inventive concept, the scope of which is defined by the appended claims and their equivalents. As used in this disclosure, the term “preferably” is non-exclusive and means “preferably, but not limited to.” Terms in the claims should be given their broadest interpretation consistent with the general inventive concept as set forth in this description. For example, the terms “coupled” and “connect” (and derivations thereof) are used to connote both direct and indirect connections/couplings. As another example, “having” and “including”, derivatives thereof and similar transitional terms or phrases are used synonymously with “comprising” (i.e., all are considered “open ended” terms)—only the phrases “consisting of” and “consisting essentially of” should be considered as “close ended”. Claims are not intended to be interpreted under 112 sixth paragraph unless the phrase “means for” and an associated function appear in a claim and the claim fails to recite sufficient structure to perform such function.

What is claimed is:

1. A nozzle chip cleaning apparatus of an inkjet printer, comprising:
a flexible bag disposed in a housing to face a nozzle chip of an inkjet head and to be filled with fluid;
an oscillation device to vibrate the flexible bag; and
a moving apparatus to move the housing so that the flexible bag reaches a surface of the nozzle chip.

2. The nozzle chip cleaning apparatus of claim 1, wherein the oscillation device is an ultrasonic device.

3. The nozzle chip cleaning apparatus of claim 1, wherein the moving apparatus comprises:
a cam shaft connected with the housing to rotate and move the housing; and
a driving motor to rotate the cam shaft.

4. The nozzle chip cleaning apparatus of claim 1, further comprising:
a flexible bag cleaning unit to clean a surface of the flexible bag contacted by the nozzle chip.

5. The nozzle chip cleaning apparatus of claim 4, wherein the flexible bag cleaning unit comprises a spray head, which has a chamber to hold a cleaning solution, spray holes to spray the cleaning solution to the outside, and an oscillation device coupled to the chamber,
wherein the oscillation device oscillates to spray the cleaning solution onto the surface of the flexible bag through the spray holes.

6. The nozzle chip cleaning apparatus of claim 1, further comprising a buffer spring to absorb shock generated when the flexible bag reaches the surface of the nozzle chip by supporting the flexible bag.

7. An inkjet printer, comprising:
an inkjet head to emit ink droplets onto a printing medium through a nozzle chip to form an image; and
a nozzle chip cleaning apparatus to clean the nozzle chip,
wherein the nozzle chip cleaning apparatus comprises:
a flexible bag disposed in a housing to face the nozzle chip of the inkjet head and to be filled with fluid;
an oscillation device to vibrate the flexible bag; and
a moving apparatus to move the housing to contact a surface of the nozzle chip with the flexible bag.

8. The inkjet printer of claim 7, wherein the oscillation device is an ultrasonic device.

9. The inkjet printer of claim 7, wherein the moving apparatus comprises:
a cam shaft connected to the housing to rotate about a moving trace of the housing; and
a driving motor to rotate the cam shaft.

10. The inkjet printer of claim 7, further comprising a flexible bag cleaning unit to clean a surface of the flexible bag contacted by the nozzle chip.

11. The inkjet printer of claim 10, wherein the flexible bag cleaning unit comprises:
a spray head having a chamber to admit a cleaning solution;
spray holes to emit the cleaning solution in the chamber to the outside; and
an oscillation device disposed in the chamber,
wherein the oscillation device oscillates to spray the cleaning solution onto the surface of the flexible bag through the spray holes.

12. The inkjet printer of claim 7, further comprising a buffer spring to absorb shock generated when the flexible bag reaches the surface of the nozzle chip by supporting the flexible bag.

13. A nozzle chip cleaning apparatus for an inkjet printer, comprising:
a flexible bag adapted to contain fluid; and
a device to position the flexible bag or an inkjet printer head at a cleaning position.

14. The nozzle chip cleaning apparatus of claim 13, wherein the device reciprocally moves the flexible bag from a first position to contact a surface of the inkjet printer head in a second position.

15. The nozzle chip cleaning apparatus of claim 14, wherein the flexible bag moves along the surface of the inkjet printer head in the second position.

16. The nozzle chip cleaning apparatus of claim 15, further comprising:
an oscillation device to vibrate the flexible bag in the second position,
wherein the oscillation device is an ultrasonic device.

17. The nozzle chip cleaning apparatus of claim 14, wherein the device comprises:
a housing coupled to the flexible bag;
a cam operably coupled to the housing to move the flexible bag from the first position to the second position.

18. The nozzle chip cleaning apparatus of claim 14, further comprising:
a buffer to absorb shock when the flexible bag is moved to the second position.

19. The nozzle chip cleaning apparatus of claim 13, wherein the device is coupled to the flexible bag to reciprocally move the flexible bag from a plurality of first positions to contact the surface of an array inkjet printer head in a plurality of corresponding second positions.

20. The nozzle chip cleaning apparatus of claim 19, the device comprising:
a housing coupled to the flexible bag;
a cam operably coupled to the housing to rotate and move the flexible bag from at least one first position to a corresponding second position;
a first driving motor coupled to the cam,
a driving unit operably coupled to the housing to move the flexible bag among the plurality of first positions; and
a second driving motor coupled to the driving unit.

21. The nozzle chip cleaning apparatus of claim 13, further comprising:
a flexible bag cleaning unit to clean the flexible bag.

22. An image processing apparatus, comprising:
an inkjet head to emit ink droplets through a nozzle chip; and
a nozzle chip cleaning apparatus to clean the nozzle chip, wherein the nozzle chip cleaning apparatus comprises:
a flexible bag adapted to contain fluid and to contact an emitting surface of the nozzle chip.

23. A method of cleaning an image processing apparatus, comprising:
emitting ink droplets through a nozzle chip; and
reciprocally moving a flexible bag adapted to contain fluid between a first position adjacent a surface of the nozzle chip and a second position.

24. The method of claim 23, further comprising wiping the surface of the nozzle chip with the flexible bag in the first position.

25. The method of claim 24, further comprising:
coupling the flexible bag to a housing; and
reducing movement of the flexible bag as the housing is moved to the first position.
